(19) United States
(12) Patent Application Publication
(10) Pub. No.: US 2026/0159924 A1
(43) Pub. Date: Jun. 11, 2026

(54) TUNGSTEN, MOLYBDENUM, OR A COMBINATION THEREOF BASED ALLOYS FOR PRINTABILITY, AND METHODS OF MAKING AND USING THEREOF

(71) Applicants: UNIVERSITY OF NORTH TEXAS, Dallas, TX (US); United States of America as represented by the Administrator of NASA, Washington, DC (US)

(72) Inventors: Rajiv S. MISHRA, Dallas, TX (US); Prithvi AWASTHI, Dallas, TX (US); Fredrick MICHAEL, Huntsville, AL (US)

(21) Appl. No.: 19/182,065

(22) Filed: Apr. 17, 2025

Related U.S. Application Data
(60) Provisional application No. 63/636,452, filed on Apr. 19, 2024.

(51) Int. Cl. C22C 27/04; B22F 10/28; B33Y 70/00

(52) U.S. Cl. CPC C22C 27/04; B33Y 70/00; B22F 10/28; B22F 2301/20

(57) ABSTRACT

An alloy comprises: at least one IUPAC Group 6 element in an amount of at least about 80 weight percent; and at least one IUPAC Groups 13 and 14 element is an amount of at least about 0.01 weight percent, all based on a total weight of the alloy. In some embodiments, methods for making the alloy comprises using a laser-powder bed fusion (L-PBF) at a suitable laser-power (P), a scanning-speed (ν), a temperature (t), and a hatch distance (hd) for forming an alloy, and its uses include as comprised in a fuel cladding, a fuel matrix, a fuel element, a channel material in a nuclear thermal propulsion engine, a refractory alloy for a space propulsion sub-component, a rocket nozzle, a wing leading edge heat pipe, a nuclear casing, a thrust chamber, or a combination thereof.

### CROSS-REFERENCE TO RELATED APPLICATIONS

This application claims the benefit of U.S. Provisional Application No. 63/636,452, filed on Apr. 19, 2024, and entitled “TUNGSTEN, MOLYBDENUM, OR A COMBINATION THEREOF BASED ALLOYS FOR PRINTABILITY, AND METHODS OF MAKING AND USING THEREOF”, which is incorporated herein by reference in its entirety for all purposes.

### STATEMENT REGARDING FEDERALLY FUNDED RESEARCH OR DEVELOPMENT

None.

### BACKGROUND

Different manufacturing techniques can be utilized for producing articles, using such typical techniques such as machining, casting, forging, extruding, stamping, or welding. Such techniques can be applied depending on the material properties, design complexity, quantity required, cost constraints, tolerances and precisions, and other factors. More recent techniques can include three-dimensional printing using various powders for producing articles. However, there are shortcomings in these techniques in not being particularly suited for processing high-performance alloys and high entropy alloys.

### SUMMARY

In some embodiments, an alloy can include: at least one IUPAC Group 6 element in an amount of at least about 80 weight percent; and at least one IUPAC Groups 13 and 14 element is an amount of at least about 0.01 weight percent, all based on a total weight of the alloy.

In some embodiments, an alloy can include a formula of at least one of: W—Cr—C(—O); W—Nb—C(—O); W—Ta—Zr—C(—O); W—(Hf/Ta/Mo)—X—Y—C(—O), where X and Y are, independently, elements; or Mo—Ti—Zr—C(—O).

In some embodiments, a method for forming an alloy can include printing a metal alloy composition of at least one element of from IUPAC Groups 3-6, and an element from IUPAC Group 13 or 14 by laser-powder bed fusion (L-PBF) at a suitable laser-power (P), a scanning-speed (ν), a temperature (t), and a hatch distance (hd) for forming an alloy.

These and other features will be more clearly understood from the following detailed description taken in conjunction with the accompanying drawings and claims.

### BRIEF DESCRIPTION OF THE DRAWINGS

For a detailed description of the aspects of the presently disclosed subject matter, reference will now be made to the accompanying drawings.

FIG. 1 is a schematic depiction of a proposed framework applying a modified Olson approach of integrated alloy design and development for advanced manufacturing processes for development of high-performance alloys and high entropy alloys for laser powder bed fusion additive manufacturing (L-PBFAM) and direct energy deposition additive manufacturing (DED-AM).

FIGS. 2A-E are graphical depictions and a photographic representation of, namely, a calculation of phase diagram (CALPHAD) simulation used to develop a novel tungsten-chromium (W—Cr) alloy that provides liquid backfilling at the later stages of solidification. This yields completely or substantially crack-free alloys built at various processing conditions. Graphical depictions: A) plot temperature versus mass percent tungsten and chromium in a spinodal decomposition for a sample having 9 weight percent chromium; B) temperature versus mole fraction of solid (fₛ) for a sample having 9 weight percent chromium and 0.3 weight percent carbon; a graphical depiction; C) plots superior hardness of samples consistent with the invention in comparison to various additive manufactured (AM) tungsten-based alloys from literature; a graphical depiction; D) of stress versus strain depicts the compression stress-strain curves showing high strength and plasticity representing a breakthrough in additive manufacturing of tungsten-alloys; and the photographic representation; and E) shows a sample magnified on a micron scale and highlighting elements tungsten (W), chromium (Cr), carbon (C), and oxygen (O).

FIGS. 3A-C are graphical depictions and a photographic representation of nanoindentation delineating mechanical heterogeneity in L-PBFAM W—Cr alloy: A) hardness-modulus distribution; B) distinctive force-displacement and stress-strain curves; and C) electron backscatter diffraction (EBSD) maps showing microstructure variation of the indented region.

FIGS. 4A-G are graphical depictions and a photographic representation of, namely, a calculation of phase diagram (CALPHAD) simulation used to develop a novel tungsten-niobium (W—Nb—C) alloy that provides liquid backfilling at the later stages of solidification. This yields completely or substantially crack-free alloys built at various processing conditions. Graphical depiction of thermodynamic simulations for alloy design: A) plots pseudo-binary phase diagram of tungsten, niobium and carbon for sample having composition of 10 weight percent niobium with varying weight of carbon up to 2-weight percent, and plots temperature vs mole fraction of solid (fₛ) present in melt pool based on Scheil-Gulliver Solidification Simulations (SGSS) of tungsten with 10 weight percent niobium and 0.45 percent carbon; B) a photographic representation shows a multi-scale microstructural characterization of low magnification component scale image shows minimal pores near-crack free build; C) a micrograph spanning multiple melt pools shows partially melted W powders on top end of the pool; D) a high magnification image of the top region and corresponding energy-dispersive spectroscopy (EDS) maps showing the distribution of tungsten (W), niobium (Nb), carbon (C) and oxygen (O); E-F) magnified images capturing fine-scale dendrites and surrounding carbides and oxides; and G) an image of trapped oxide and carbide particles in the W-rich SS matrix, inset and an image shows the EDS line scan.

FIGS. 5A-D are graphical and a photographic representation of nanoindentation investigation: A) a graphical depiction of microhardness variation across the specimen height; B) images of microstructure of indented regions, b1) a top region, and a b2) bottom region of a pool; C) a graphical depiction of corresponding P-h curves; and D) a graphical depiction of nanoindentation stress-strain curves showing phase-dependent mechanical response.

### DETAILED DESCRIPTION

As used herein, the term “and/or” can mean one, some, or all elements depicted in a list. As an example, “A and/or B” can mean A, B, or a combination of A and B.

The term “about” or “approximately” as used herein when referring to a measurable value such as a parameter, an amount, a temporal duration, and the like, is meant to encompass variations of plus or minus (+/−)10% or less, preferably +/−5% or less, more preferably +/−1% or less, and still more preferably +/−0.1% or less of and from the specified value, or within one standard deviation of a mean, insofar such variations are appropriate to perform the disclosed embodiments.

As used herein, the term “alloy” refers to a solid or liquid mixture of two or more metals, or of one or more metals with certain metalloid elements, e.g., silicon, optionally including other elements such as carbon, boron and oxygen.

As used herein, the term “dendrite” refers to a characteristic tree-like structure of crystals that grows as molten metal solidifies.

As used herein, the term “eutectic” refers to a homogeneous solid mix of atomic and/or chemical species forming a super lattice having a unique molar ratio between the components. At the unique molar ratio, the mixtures melt as a whole at a specific temperature—the eutectic temperature. At other molar ratios, one component of the mixture can melt at a first temperature and the other component(s) can melt at a higher temperature.

As used herein, the term “microstructure” refers to the fine structure of an alloy (e.g., grains, cells, dendrites, rods, laths, lamellae, precipitates, etc.) that can be visualized and examined with a microscope at a magnification of at least 25 times. Microstructure can also include nanostructure, i.e., structure that can be visualized and examined with more powerful tools, such as electron microscopy, atomic force microscopy, X-ray computed tomography, etc.

As used herein, the term “Vickers hardness” refers to a hardness measurement determined by indenting the test material with a pyramidal indenter, particular to Vickers hardness testing units, subjected to a load of 50 to 1000 gram force (gf) for a period of time and measuring the resulting indent size. Vickers hardness or Vickers pyramid number may be expressed in units of HV.

As used herein, the term “yield strength” or “yield stress” refers to the stress a material can withstand without permanent deformation, in other words, the stress at which a material begins to deform plastically.

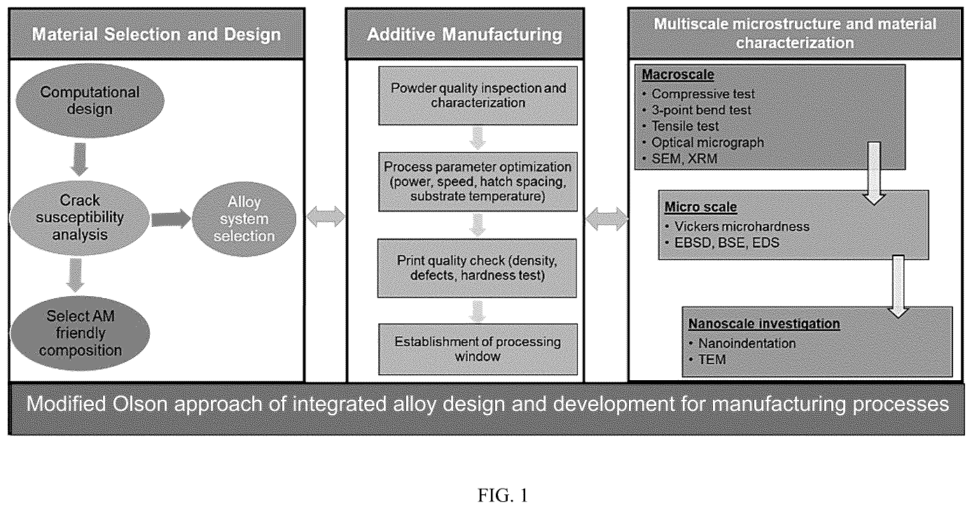

As depicted in FIG. 1, a proposed framework of applying a modified Olson approach of integrated alloy design and development for advanced manufacturing processes for development of high-performance alloys and high entropy alloys for laser powder bed fusion additive manufacturing (L-PBFAM) is depicted. In some embodiments, a framework for processing tungsten (W)-based alloys using L-PBFAM and direct energy deposition additive manufacturing (DED-AM) techniques by implementing a modified Olson approach for alloy development may be used.

In some embodiments, a powder may be fused. In some aspects, an atomized powder mixture for laser-powder bed fusion additive three-dimensional printer or direct energy deposition printer can include an amount of tungsten of about 80 weight percent to about 82 weight percent, about 82 weight percent to about 84 weight percent, about 84 weight percent to about 86 weight percent, about 86 weight percent to about 88 weight percent, about 88 weight percent to about 90 weight percent, about 90 weight percent to about 92 weight percent, about 92 weight percent to about 94 weight percent, about 94 weight percent to about 96 weight percent, about 96 weight percent to about 98 weight percent, or about 98 weight percent to about 99 weight percent; an amount of chromium of about 0.1 weight percent to about 1 weight percent, about 1 weight percent to about 2 weight percent, about 2 weight percent to about 3 weight percent, about 3 weight percent to about 4 weight percent, about 4 weight percent to about 5 weight percent, about 5 weight percent to about 6 weight percent, about 6 weight percent to about 7 weight percent, about 7 weight percent to about 8 weight percent, about 8 weight percent to about 9 weight percent, about 9 weight percent to about 10 weight percent, about 10 weight percent to about 11 weight percent, or about 11 weight percent to about 12 weight percent; and an amount of carbon of about 0.01 weight percent to about 0.05 weight percent, about 0.05 weight percent to about 0.1 weight percent, about 0.1 weight percent to about 0.15 weight percent, about 0.15 weight percent to about 0.2 weight percent, about 0.2 weight percent to about 0.25 weight percent, about 0.25 weight percent to about 0.3 weight percent, about 0.3 weight percent to about 0.4 weight percent, about 0.4 weight percent to about 0.5 weight percent, about 0.5 weight percent to about 0.6 weight percent, about 0.6 weight percent to about 0.7 weight percent, about 0.7 weight percent to about 0.8 weight percent, about 0.8 weight percent to about 0.9 weight percent, or about 0.9 weight percent to about 1.0 weight percent based on the total weight of the atomized powder mixture.

Calculation of phase diagram (CALPHAD) simulations can enable identification of an alloy composition with low susceptibility coefficient for cracking and a small range of solidification temperature. Cracking susceptibility for the disclosed compositions is calculated via several methods that provide confluence and confirm each other. These are the vulnerability time solidification cracking susceptibility methods in the Calphad Thermocalc software implementation where pair-wise element weight percent (wt. %) or mole fraction is iterated through while holding all other amounts of the elements constant. For example, if W-X-Y then varying on a three-dimensional (3-D) grid and Y pairwise while holding the remainder of W constant, would identify cracking suppression or enhancement. Furthermore, and similarly W-X-Y-Z would have X and Y varied, X and Z varied, and Y and Z varied while holding all else constant or remaindered. A second utilized method providing additional guidance (and confluence) is the Kuo-Scheil extreme value of the gradient of solidification versus the square root of the solidification fraction method by Sowards, et al., (NASA TM and now included in Thermocalc 2024a). The equilibrium and quasi-equilibrium Scheil classic, and Scheil with solute trapping and Scheil with and without fast diffusers are also calculated in the presence of impurities such as oxygen. Furthermore, material-to-material computation while varying oxygen and/or carbon are provided for phases evolution during solidification. In all of these cases, suppression of cracking even while the identification of what phases and species produced is examined closely in order to thoroughly characterize the solidification powder bed fusion process. Computationally guided experiments can reduce the time to achieve dense and crack-free W-alloy parts. Multiscale mechanical and microstructural investigation can be carried out for detailed structure-property correlations. In some embodiments, the alloy system is designed to maintain high-temperature structural properties by incorporating tungsten in excess of about 80 weight percent (wt. %). The primary alloying elements (chromium (Cr), vanadium (V), niobium (Nb), tantalum (Ta), rhenium (Re), titanium (Ti) and/or molybdenum (Mo)) may be carefully selected to ensure desired material properties. Additionally, the alloy system can contain secondary elements such as carbon (C), boron (B), zirconium (Zr), yttrium (Y), and hafnium (Hf), or combinations thereof. The tungsten-chromium (W—Cr) alloy system can have many unique features (including spinodal decomposition) development of hierarchical and heterogeneous microstructure for synergistic strength-ductility enhancement.

In some embodiments, the tungsten can be in an amount of at least about 82 weight percent, about 84 weight percent, about 86 weight percent, about 88 weight percent, about 90 weight percent, about 92 weight percent, about 94 weight percent, about 96 weight percent, about 98 weight percent, or about 99 weight percent, based on the total weight of the alloy. In some embodiments, the tungsten can be in amount of no more than about 99 weight percent, about 98 weight percent, about 96 weight percent, about 94 weight percent, about 92 weight percent, about 90 weight percent, about 88 weight percent, about 86 weight percent, about 84 weight percent, or about 82 weight percent, based on the total weight of the alloy. In some embodiments, the tungsten can be in an amount of about 80 weight percent to about 82 weight percent, about 82 weight percent to about 84 weight percent, about 84 weight percent to about 86 weight percent, about 86 weight percent to about 88 weight percent, about 88 weight percent to about 90 weight percent, about 90 weight percent to about 92 weight percent, about 92 weight percent to about 94 weight percent, about 94 weight percent to about 96 weight percent, about 96 weight percent to about 98 weight percent, or about 98 weight percent to about 99 weight percent, based on the total weight of the alloy.

Additive manufacturing (AM) can fabricate near fully dense and crack-free, W-based alloy specimens with improved high-temperature mechanical properties and acceptable room temperature ductility. CALPHAD simulations can be utilized to optimize the chemical composition for eutectic solidification for improved printability and enhanced mechanical performance. Process parameters can be optimized to achieve optimal mechanical properties at both low and high temperatures. Multiscale mechanical testing and characterization can be conducted to establish process microstructure-properties relationships for meeting performance standards of a final product.

The L-PBFAM can manufacture three-dimensional printed parts produced with a high degree of accuracy and precision, requiring minimal post-processing, e.g., net-shaped parts, and avoid the difficult and costly machining of W-based alloys. The W—Cr phase diagram can develop a hierarchical microstructure, which can be an isomorphous system with spinodal decomposition at lower temperatures. As a result, W and Cr atoms tends to segregate into separate layers or lamellae. During solidification, the W matrix can have solid solution of chromium. In the solid state, the W—Cr system may undergo spinodal decomposition, and such microstructure can increase the strength of the material. Microstructure can be further tailored by post-build heat treatment in an isomorphous region and aging in spinodal region. A factorial design of experiments can develop process parameters, which may focus on achieving maximum relative density and desired microstructural features. Minor alloying addition to the W—Cr system can aid in grain refinement to activate various solidification pathways and strengthening mechanisms. The W—Nb phase diagram can develop a single body-centered cubic (BCC) phase microstructure with solid solution of niobium.

In some embodiments, the computational aspect can use CALPHAD software for Scheil solidification simulations to determine the constituent phases after rapid solidification, as well as hot cracking zone and change in temperature values. This information can aid in the selection of the alloy systems with the desired printability characteristics for L-PBFAM. The optimal composition(s) can be based on the best combination of mechanical performance and printability. Multiscale microstructural and mechanical testing can cover basic static properties, such as grain size, precipitate formation, heterogeneous nucleation, room temperature yield, ultimate tensile strength, and elongation to failure. Generally, scanning and transmission electron microscopy scanning electron microscopy (SEM) and transmission electron microscopy (TEM) is used to characterize the microstructure.

Additive manufacturing of refractory metals and alloys can present challenges due to multiple factors. First, the formation of oxides in the grain boundary can result in cracking due to the high affinity for oxygen in refractory metals. Second, ductile-to-brittle transition temperatures (DBTT) of up to 700° C. have been reported in tungsten, which can lead to processing difficulties. Moreover, there is currently a lack of complete thermodynamic databases and literature for refractory metals, resulting in a lack of readiness for additive manufacturing of refractories. Thus, generally strategies are required to enable printing, up until now, difficult to print or unprintable alloys.

Refractory metals and alloys can offer great potential for use in environments with high temperatures where conventional high-temperature alloys, such as nickel-based superalloys, are no longer feasible. Tungsten (W) having a melting point temperature (Tₘ) of 3422° C. is the refractory element with the highest melting point and has been widely used as a fuel cladding, fuel matrix, fuel element, and channel material in nuclear thermal propulsion applications. These properties make refractory alloys suitable for use in space propulsion sub-components, rocket nozzles, wing leading edge heat pipes, nuclear casings, and thrust chambers.

Tungsten, known for its BCC crystal structure, can be susceptible to brittleness and high DBTT, which can reduce its applicability. One possible solution is by incorporating rhenium, which significantly improves tungsten's high-temperature mechanical properties when strengthened by hafnium carbide (HfC). However, the high cost of such alloying materials opens the opportunity for economically feasible options to reduce total manufacturing costs. To achieve this, the addition of Cr, V, Nb, Ti and Mo to replace Re can be adopted, and the CALPHAD method can be used to optimize compositions for printability. Preliminary studies are performed by creating temperature versus mole fraction of solid plots using Scheil solidification simulations to identify the freezing range and hot cracking zones. Scheil solidification is a desired choice for AM because of simulating with no back diffusion during solidification, which can replicate the extremely fast solidification rates in the AM process.

Additionally, this disclosure provides a method for forming the alloy, such as a tungsten alloy, comprising printing a metal alloy composition of W, Cr, C and W, Nb and C by laser-powder bed fusion (L-PBF) at a suitable laser-power (P) and scanning-speed (ν) for forming the alloy according to the disclosure herein.

In some embodiments, P is about 150 Watts to about 1,000 Watts, about 400 Watts to about 900 Watts, or about 550 Watts to about 700 Watts. In other embodiments, P is about 500 Watts, about 550 Watts, about 600 Watts, about 650 Watts, about 700 watts, about 750 watts, about 800 watts, about 850 watts, about 900 watts or no more than about 950 Watts.

In some embodiments, ν is about 100 millimeter per second (mm/s) to about 2,000 mm/s. In some other embodiments, ν is about 200 mm/s, about 300 mm/s, about 400 mm/s, about 500 mm/s, about 600 mm/s, about 700 mm/s, about 800 mm/s, about 900 mm/s, about 1,000 mm/s, about 1,100 mm/s, about 1,200 mm/s, about 1,300 mm/s, about 1,400 mm/s, about 1,500 mm/s, about 1,600 mm/s, about 1,700 mm/s, about 1,800 mm/s, or about 1,900 mm/s.

In some other embodiments, the alloy has a yield strength of about 500 megapascal (MPa) to about 1,000 MPa, or about 800 MPa to about 900 MPa, or about 700 MPa, about 720 MPa, about 740 MPa, about 760 MPa, about 780 MPa, about 800 MPa, about 820 MPa, or about 825 MPa; a maximum compressive strength of about 1,000 MPa to about 1,500 MPa, or about 1,300 MPa to about 1,400 MPa, or about 1,200 MPa, about 1,240 MPa, about 1,280 MPa, about 1,320 MPa, or about 1,340 MPa; a Vickers Pyramid Number of at least about 500 HV, about 520 HV, about 540 HV, about 560 HV, about 580 HV, about 600 HV, about 620 HV, about 640 HV, about 660 HV, about 680 HV, about 700 HV, about 720 HV, about 740 HV, about 760 HV, about 780 HV, about 800 HV or about 820 HV; or a combination thereof. Atomized powders of alloys disclosed herein are formed using methods of powder metallurgy that are known to persons skilled in the art.

Samples can be fabricated at any suitable AM facility. Process development for the selected composition(s) can be designed in a factorial fashion, where the variables laser power, scanning speed, layer thickness, and hatch distance may be optimized. A range of process parameters can be about 400 Watt (W) to about 950 W for laser power, about 300 mm/s to about 700 mm/s for scanning speed, about 400 degrees Celsius (° C.) to about 1,000° C. for powder bed temperature, about 40 microns (μm) to about 120 μm for hatch distance and about 20 microns (μm) to about 100 μm for layer thickness.

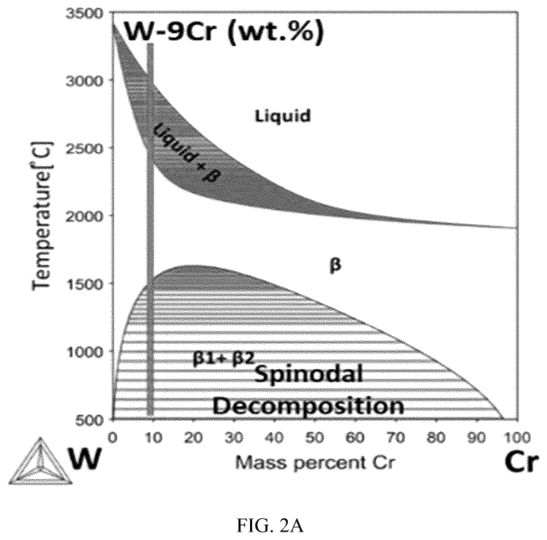

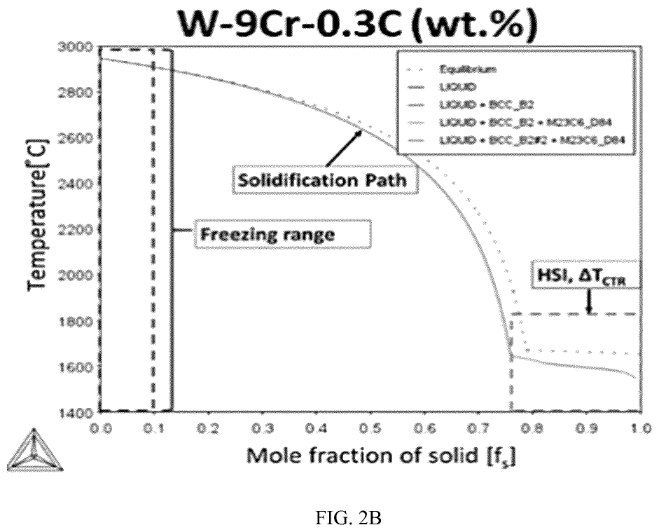

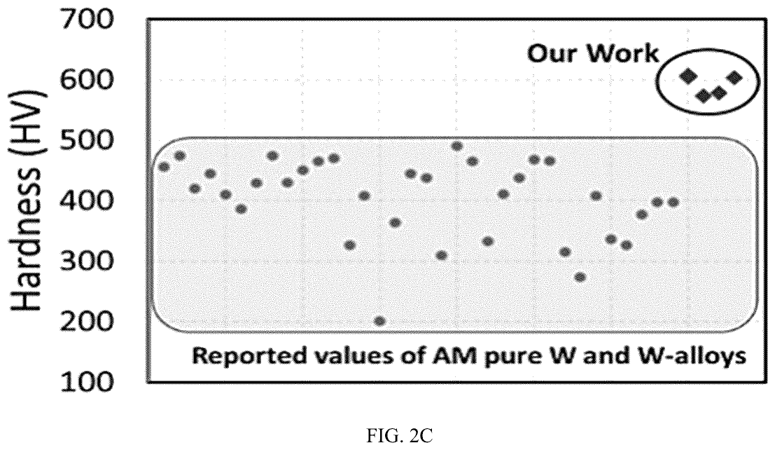

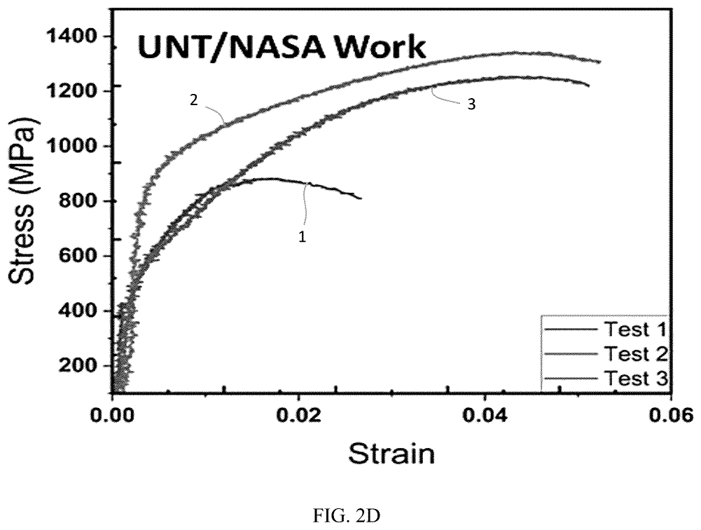

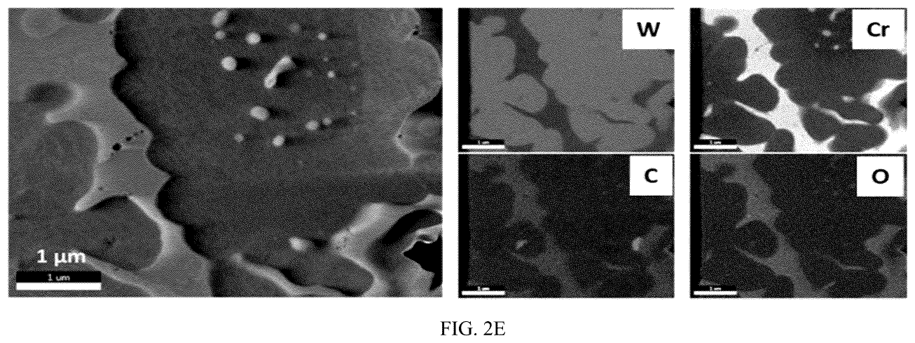

FIGS. 2A-E are graphical depictions and a photographic representation of, namely, a calculation of phase diagram (CALPHAD) simulation used to develop a novel tungsten-chromium (W—Cr) alloy that provides liquid backfilling at the later stages of solidification. This yields completely or substantially crack-free alloys built at various processing conditions. Graphical depictions: A) plot temperature versus mass percent tungsten and chromium in a spinodal decomposition for a sample having 9 weight percent chromium; B) temperature versus mole fraction of solid (fₛ) for a sample having 9 weight percent chromium and 0.3 weight percent carbon; a graphical depiction; C) plots superior hardness of samples consistent with the invention in comparison to various additive manufactured (AM) tungsten-based alloys from literature; a graphical depiction; D) of stress versus strain depicts the compression stress-strain curves showing high strength and plasticity representing a breakthrough in additive manufacturing of tungsten-alloys; and the photographic representation; and E) shows a sample magnified on a micron scale and highlighting elements tungsten (W), chromium (Cr), carbon (C), and oxygen (O).

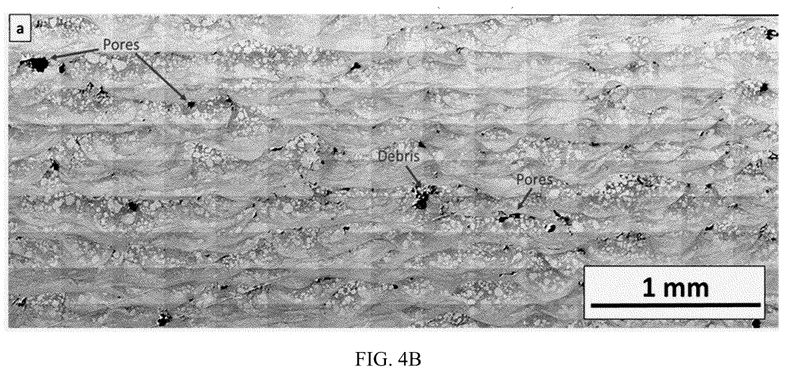

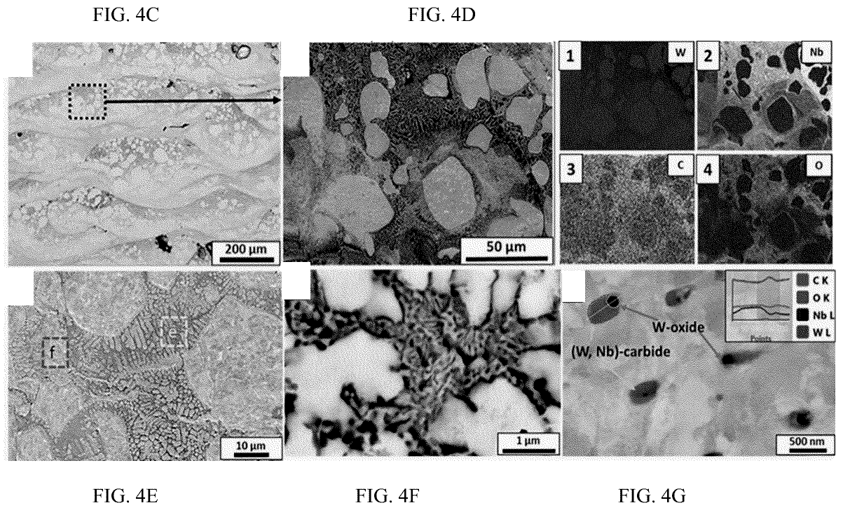

FIGS. 4A-G are graphical depictions and a photographic representation of, namely, a calculation of phase diagram (CALPHAD) simulation used to develop a novel tungsten-niobium (W—Nb—C) alloy that provides liquid backfilling at the later stages of solidification. This yields completely or substantially crack-free alloys built at various processing conditions. Graphical depiction of thermodynamic simulations for alloy design: A) plots pseudo-binary phase diagram of tungsten, niobium and carbon for sample having composition of 10 weight percent niobium with varying weight of carbon up to 2-weight percent, and plots temperature vs mole fraction of solid (fₛ) present in melt pool based on SGSS of tungsten with 10 weight percent niobium and 0.45 percent carbon; B) a photographic representation shows a multi-scale microstructural characterization of low magnification component scale image shows minimal pores near-crack free build; C) a micrograph spanning multiple melt pools shows partially melted W powders on top end of the pool; D) a high magnification image of the top region and corresponding EDS maps showing the distribution of tungsten (W), niobium (Nb), carbon (C) and oxygen (O); E-F) magnified images capturing fine-scale dendrites and surrounding carbides and oxides; and G) an image of trapped oxide and carbide particles in the W-rich SS matrix, inset and an image shows the EDS line scan.

A completely or substantially crack-free alloy can have any suitable composition. In some embodiments, an alloy can include at least one IUPAC Group 6 element in an amount of at least about 80 weight percent; and at least one IUPAC Group 14 element in an amount of at least about 0.01 weight percent, all based on a total weight of the alloy. In some aspects, the at least one IUPAC Group 6 element can include tungsten, molybdenum, niobium, or a combination thereof. In some embodiments, the at least one IUPAC Group 6 element can include only tungsten or only molybdenum. In some embodiments, the at least one IUPAC Groups 13 and 14 element can include carbon and boron.

In some aspects, the alloy can further include at least one additional element of another IUPAC Group 6 element, at least one element from IUPAC Groups 3-5, and 16, or a combination thereof. In some embodiments, the at least one additional element can include another IUPAC Group 6 element having chromium. In some embodiments, the at least one additional element can include another IUPAC Group 5 element having niobium.

In some aspects, the chromium can be in an amount of at least about 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, or about 12 weight percent, based on the total weight of the alloy. In some embodiments, the chromium can be in an amount of no more than about 12 weight percent, about 11 weight percent, about 10 weight percent, about 9 weight percent, about 8 weight percent, about 7 weight percent, about 6 weight percent, about 5 weight percent, about 4 weight percent, about 3 weight percent, about 2 weight percent, or about 1 weight percent, based on the total weight of the alloy. In some aspects, the chromium can be in an amount about 0.1 weight percent to about 12 weight percent, about 0.1 weight percent to about 1 weight percent, about 1 weight percent to about 2 weight percent, about 2 weight percent to about 3 weight percent, about 3 weight percent to about 4 weight percent, about 4 weight percent to about 5 weight percent, about 5 weight percent to about 6 weight percent, about 6 weight percent to about 7 weight percent, about 8 weight percent to about 9 weight percent, about 9 weight percent to about 10 weight percent, about 10 weight percent to about 11 weight percent, or about 11 weight percent to about 12 weight percent, based on the total weight of the alloy.

In some aspects, the niobium can be in an amount of at least about 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, or about 12 weight percent, based on the total weight of the alloy. In some embodiments, the niobium can be in an amount of no more than about 12 weight percent, about 11 weight percent, about 10 weight percent, about 9 weight percent, about 8 weight percent, about 7 weight percent, about 6 weight percent, about 5 weight percent, about 4 weight percent, about 3 weight percent, about 2 weight percent, or about 1 weight percent, based on the total weight of the alloy. In some aspects, the niobium can be in an amount about 0.1 weight percent to about 12 weight percent, about 0.1 weight percent to about 1 weight percent, about 1 weight percent to about 2 weight percent, about 2 weight percent to about 3 weight percent, about 3 weight percent to about 4 weight percent, about 4 weight percent to about 5 weight percent, about 5 weight percent to about 6 weight percent, about 6 weight percent to about 7 weight percent, about 8 weight percent to about 9 weight percent, about 9 weight percent to about 10 weight percent, about 10 weight percent to about 11 weight percent, or about 11 weight percent to about 12 weight percent, based on the total weight of the alloy.

In some embodiments, the at least one additional element can include at least one IUPAC Group 3 element, having yttrium. In some aspects, the at least one additional element can include at least one IUPAC Group 4 element, including titanium, zirconium, hafnium, or a combination thereof. In some embodiments, the at least one additional element can include at least one IUPAC Group 5 element, having vanadium, tantalum, or a combination thereof, and the alloy can further include zirconium.

In some aspects, the alloy can further include an IUPAC Group 16 element, having oxygen. In some embodiments, the at least one IUPAC Group 6 element can be in an amount of at least about 82 weight percent, about 84 weight percent, about 86 weight percent, about 88 weight percent, about 90 weight percent, about 92 weight percent, about 94 weight percent, about 96 weight percent, about 98 weight percent, or about 99 weight percent, based on the total weight of the alloy. In some embodiments, the at least one IUPAC Group 6 element can be in an amount of no more than about 99 weight percent, about 98 weight percent, about 96 weight percent, about 94 weight percent, about 92 weight percent, about 90 weight percent, about 88 weight percent, about 86 weight percent, about 84 weight percent, or about 82 weight percent, based on the total weight of the alloy. In some aspects, the at least one IUPAC Group 6 element can be in an amount of about 80 weight percent to about 82 weight percent, about 82 weight percent to about 84 weight percent, about 84 weight percent to about 86 weight percent, about 86 weight percent to about 88 weight percent, about 88 weight percent to about 90 weight percent, about 90 weight percent to about 92 weight percent, about 92 weight percent to about 94 weight percent, about 94 weight percent to about 96 weight percent, about 96 weight percent to about 98 weight percent, or about 98 weight percent to about 99 weight percent, based on the total weight of the alloy.

In some embodiments, wherein the carbon can be in an amount of at least about 0.01 weight percent, about 0.05 weight percent, about 0.1 weight percent, about 0.15 weight percent, about 0.2 weight percent, about 0.25 weight percent, about 0.3 weight percent, about 0.35 weight percent, about 0.4 weight percent, about 0.45 weight percent, about 0.5 weight percent, about 0.55 weight percent, about 0.6 weight percent, about 0.65 weight percent, about 0.7 weight percent or about 0.75 weight percent, based on the total weight of the alloy. In some aspects, the carbon can be in an amount of no more than about 0.9 weight percent, about 0.85 weight percent, about 0.8 weight percent, about 0.75 weight percent, about 0.7 weight percent, about 0.65 weight percent, about 0.6 weight percent, about 0.55 weight percent, about 0.5 weight percent, about 0.4 weight percent, about 0.3 weight percent, about 0.25 weight percent, about 0.2 weight percent, about 0.15 weight percent, about 0.1 weight percent, about 0.05 weight percent, or about 0.01 weight percent, based on the total weight of the alloy. In some embodiments, the carbon is in an amount of about 0.01 weight percent to about 0.05 weight percent, about 0.05 weight percent to about 0.1 weight percent, about 0.1 weight percent to about 0.15 weight percent, about 0.15 weight percent to about 0.2 weight percent, about 0.2 weight percent to about 0.25 weight percent, about 0.25 weight percent to about 0.3 weight percent, about 0.3 weight percent to about 0.4 weight percent, about 0.4 weight percent to about 0.5 weight percent, or about 0.5 weight percent to about 0.6 weight percent, based on the total weight of the alloy.

In some embodiments, the crack-free printing domain can be extended as well as the relative density of the samples may be maximized, while closely monitoring the microstructural evolution. Scan parameters can be optimized using cube geometry and objects with three-dimensional (3D) features can be printed for selected compositions. In some embodiments, laser powder bed fusion (L-PBF) manufacturing of compositions of about 9 wt. % chromium, 0.3 wt. % carbon, with the remainder tungsten (W—9Cr—0.3C wt. %) can be undertaken. The composition of W—9Cr—0.3C wt. % can be selected after analysis of Schiel solidification simulations of different compositions for the first trial of prints, as depicted in, e.g. FIGS. 2A and 2B. The print parameters can have laser power in the range of about 550 W to about 700 W while maintaining scanning speed at about 400 mm/s, hatch spacing at about 0.1 mm, layer thickness at about 0.05 mm, and a temperature of about 500° C. for a powder bed platform. The platform temperature can reach 750° C. by the end of printing due to laser heat accumulation. Referring to FIG. 2E, the initial compressive stress-strain response of a crack-free print alloy is depicted. The initial properties represent a breakthrough in printing of W alloy.

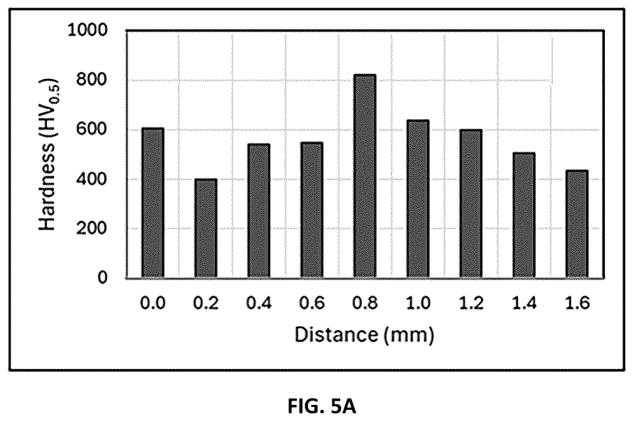

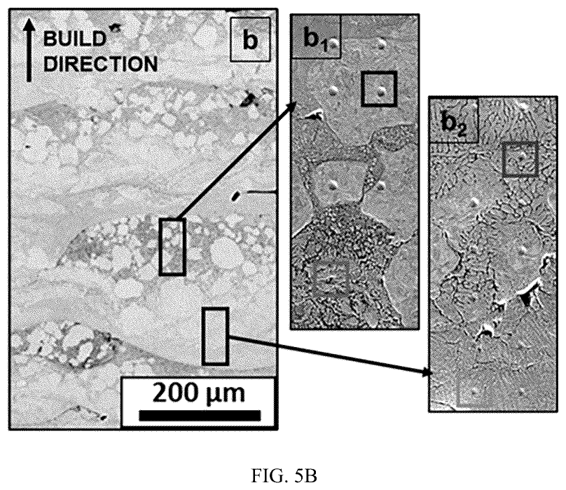

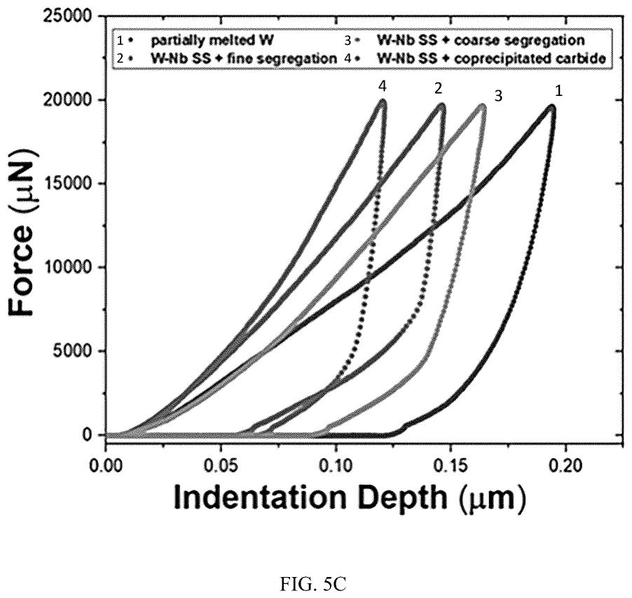

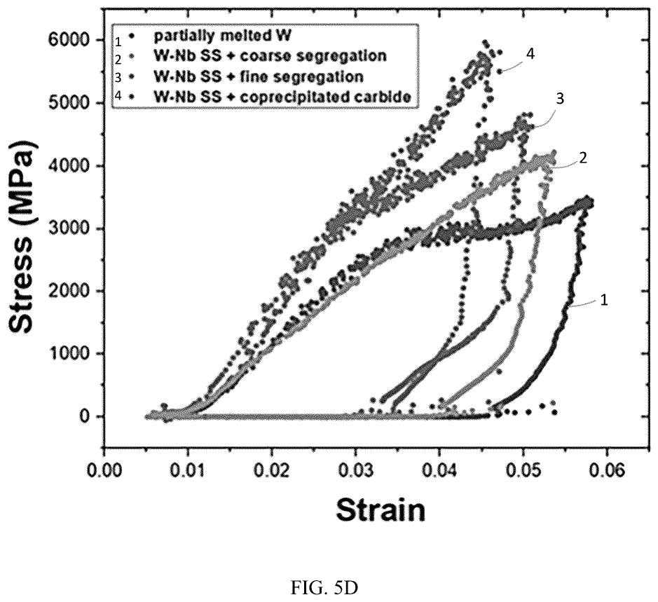

In some embodiments, the crack-free printing domain can be extended as well as the relative density of the samples may be maximized, while closely monitoring the microstructural evolution. Scan parameters can be optimized using cube geometry and objects with 3D features can be printed for selected compositions. In some embodiments, L-PBF manufacturing of compositions of about 10 wt. % niobium, 0.45 wt. % carbon, with the remainder tungsten (W—10Nb—0.45C wt. %) can be undertaken. The composition of W—10Nb—0.45C wt. % can be selected after analysis of Schiel solidification simulations of different compositions for the first trial of prints, as depicted in, e.g. FIG. 4A. The print parameters can have laser power in the range of about 600 W to about 900 W while maintaining scanning speed at about 400 mm/s to 500 mm/s, hatch spacing at about 0.1 mm, layer thickness at about 0.05 mm, and a temperature of about 600° C. for a powder bed platform. The platform temperature can reach 800° C. by the end of printing due to laser heat accumulation. Referring to FIG. 5A, the initial hardness of a crack-free print alloy is depicted. The initial properties represent a breakthrough in printing of W alloy.

The deposited coupons and demonstration articles can undergo extensive SEM analysis, including backscattered electron (BSE) imaging for observing the atomic contrast image of the samples, secondary electron (SE) imaging for fractography of the fracture surfaces, electron backscattered diffraction (EBSD) analysis for local texture, misorientation, and grain orientation spread (GOS) analysis, and energy-dispersive spectroscopy (EDS) analysis for elemental segregation events. TEM can be used to explore potentially existing dislocation cell-structures, nano-scale precipitation, and grain structure of the fine grains nucleated adjacent to the carbide particles. The TEM analysis can also be employed for dislocation characterization and observing microstructural features such as mechanical twins. The X-ray diffraction (XRD) analysis can be employed to investigate the bulk texture and analyze the constituent phases of the samples. Atom probe tomography can be utilized if 3D elemental analysis is undertaken. The X-ray microscopy (XRM) analysis can be undertaken for further describing the tomography of a three-dimensional microstructure. Collecting microstructural information of the printed alloy products establishes process-microstructure property relationships and underlying deformation mechanisms responsible for static and cyclic failure.

In some embodiments, a printed W—9Cr—0.3C wt. % specimen demonstrates a crack-free surface, albeit there are a few keyholes due to high energy density. High-magnification of SEM images depict backfilling of chromium in the cracked regions. Additionally, the grain boundary of the tungsten-dendrites are decorated with chromium. A transmission electron microscopy and energy-dispersive spectroscopy (TEM-EDS) scan can reveal the presence of carbon and oxygen throughout the microstructure with formation of carbides and oxides, mostly in chromium-rich regions. Dislocation density is high in the tungsten-rich region whereas the presence of fine scale carbides is observed in chromium-concentrated backfilled channels, as depicted in FIG. 2E. The microstructure can be further tailored by post-AM solution treatment above 1500° C. and spinodal aging in about 600° C. to about 700° C. range. High temperature heat treatments can be conducted at any suitable facility.

In some embodiments, a printed W—10Nb—0.45C wt. % specimen demonstrates a crack-free surface, albeit there are a few keyholes due to high energy density. Low-magnification of SEM images depicts the crack-free microstructure of the alloy along the build direction with defects of spherical and aspherical pores. High magnification of SEM images depicts backfilling of carbide phase in the cracked regions. Additionally, the grain boundary of the tungsten-dendrites are decorated with niobium rich phase.

Ambient mechanical testing can be supplemented with digital image correlation (DIC) to analyze strain distribution and failure mechanisms in detail. In addition, a range of high temperature testing can be conducted between about 500° C. to about 1000° C. at initial strain rates of 0.0001 per second (s⁻¹) to 0.1 s⁻¹. To evaluate static performance of the deposited coupons, mechanical testing can include nano-indentation, compression, three-point bend, and tensile testing. Servo-hydraulic test frames including high temperature testing furnaces can be used to undertake such testing. To understand the DBTT trends in the designed alloys, low-temperature regime testing can be performed followed by detailed microstructural characterization. High temperature testing can also be conducted to assess the performance of the samples under static and cyclic loading conditions, including high temperature properties such as a conductivity measurement and a creep deformation above 1100° C. The feedback from the mechanical testing results can be employed for further enhancements in the process development.

An initial crack-free printed specimen can undergo mechanical testing, such as Vickers hardness, compression testing, and nano-indentation testing. An average hardness of 606 HV is measured in a sample printed at 700 W power for W—9Cr—0.3C wt. % alloy. A compression test of the sample reveals a yield strength (YS) of 829 MPa and a maximum compressive strength of 1344 megapascal (MPa) of W—9Cr—0.3C wt. % alloy. Vickers hardness ranging from 401 HV to 822 HV is measured depending on different location in the build on W—10Nb—0.45C wt. % alloy. These results of strength level, work hardening and plasticity in AM tungsten alloys are significant and unexpected. To obtain further insights into the mechanical behavior at nanoscale and delineate the effects of various precipitates and second phase elements, nanoindentation testing is performed with an in-situ nanomechanical testing system sold under the trade designation FT-NMT04 SEM nanoindenter by Femto Tools AG of Buchs, Switzerland. The system uses high stiffness load cells (up to and greater than 100,000 newton per meter (N/m)) and offers as standard actuation speeds ranging from 0.1 nanometer per second (nm/s) to greater than 1 millimeter per second (mm/s), making it suitable for testing very stiff and hard materials like tungsten-based alloys. Preliminary nanoindentation testing can be performed on the crack-free tungsten and chromium alloy to capture a wide variation in elastic-plastic responses in the material due to heterogeneity in phase distribution, complex trends in solidification, and the carbide strengthening effect. Data collected can include machine operation data, materials characterization data and sensor data. Additionally, the data may include the monitoring data collected from the active monitoring of a machine with sensors.

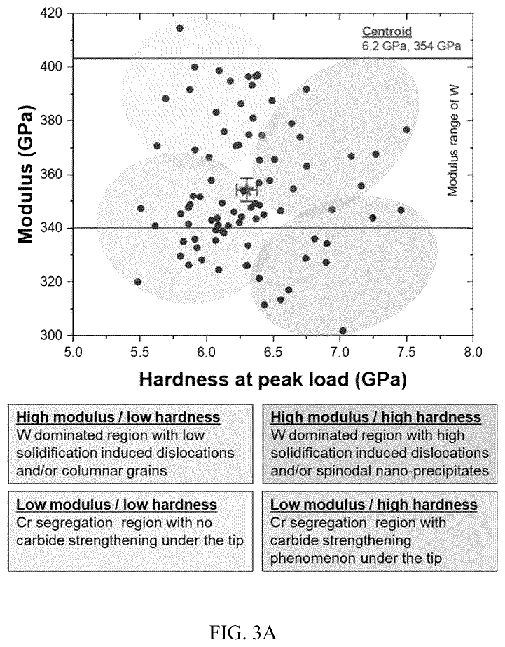

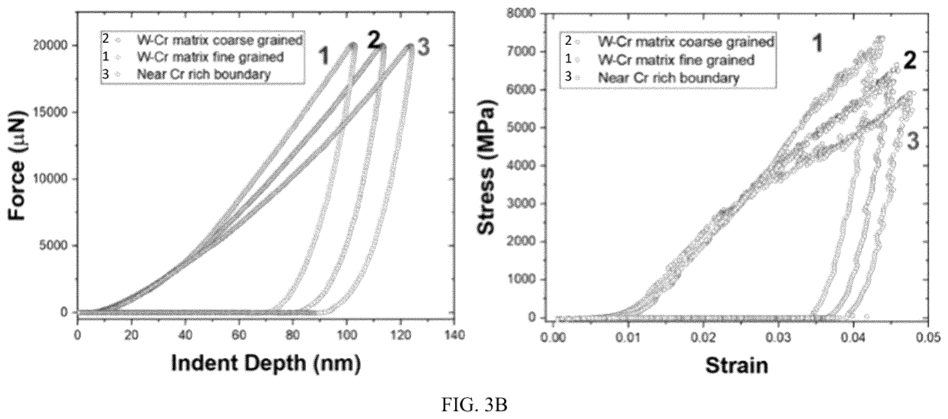

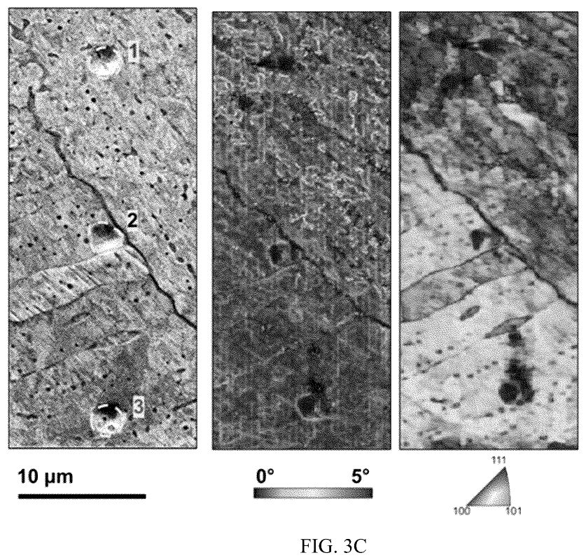

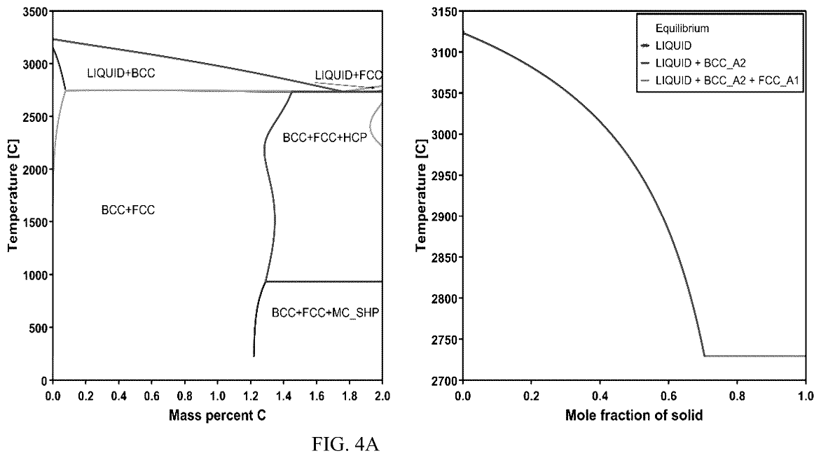

FIGS. 3A-C are graphical depictions and a photographic representation of nanoindentation delineating mechanical heterogeneity in L-PBFAM W—Cr alloy: A) hardness-modulus distribution; B) distinctive force-displacement and stress-strain curves; and C) electron backscatter diffraction (EBSD) maps showing microstructure variation of the indented region.

FIGS. 5A-5D are graphical and a photographic representation of nanoindentation investigation A) a graphical depiction of microhardness variation across the specimen height; B) images of microstructure of indented regions, b1) a top region, and a b2) bottom region of a pool; C) a graphical depiction of corresponding P-h curves; and D) a graphical depiction of nanoindentation stress-strain curves showing phase-dependent mechanical response.

As depicted, FIGS. 3A-C and FIGS. 5B-D provide outcomes of the nanoindentation testing. Application of nanoindentation can serve as a high throughput tool to delineate heterogeneity in mechanical response due to complex distribution of phases, cyclic heat distribution and multimodal grain size in alloys, high entropy alloys and superalloys developed by L-PBFAM.

In some embodiments, printed coupons and preliminary parts may include several ternary, and quaternary compositions of tungsten and possibly molybdenum alloys. These compositions can follow current CALPHAD predicted compositions of tungsten, molybdenum, or a combination thereof that are of high solidus temperature of no more than or at least about about 3,000 Kelvin (K) and include in-situ formed metal carbides and metal oxides nanometer scale particles favorably utilizable for grain refinement and enhanced strength and potentially ductility. Examples are alloys of tungsten, tantalum, zirconium, and oxygen (W—Ta—Zr—C(—O)) and tungsten, hafnium, tantalum, molybdenum, and oxygen ((W—(Hf/Ta/Mo)—X—Y—C(—O)), where X and Y are, independently, elements, as well as the molybdenum based analogs such as alloys of titanium-zirconium-molybdenum (TZM), such as molybdenum, titanium, zirconium, carbon, and oxygen (Mo—Ti—Zr—C(—O)). Additionally, externally added volume fractions of nanoparticles ‘inoculants’ can also be included using a CALPHAD approach and an iterative computational-experimental process.

These specimens can be tested and characterized to establish the crucial process-microstructure property relationships for tungsten-based and/or molybdenum-based alloys manufactured using L-PBFAM. Refractory alloys additive manufacturing build optimization (RAAMBO) in space nuclear propulsion (SNP) can be pursued to facilitate technical communications on processing parameters and qualification as well as AM specimens and parts fabrication and testing. The resulting parts and specimens, such as miniature nozzles, can be evaluated and performance compared.

In some embodiments, novel chemical compositions can be developed by varying process parameters. Mechanical testing and microstructural characterization can be undertaken for developing AM tungsten-based alloys in high-temperature environments, such as space propulsion systems, in the aerospace industry.

Having described various systems and methods herein, certain embodiments can include, but are not limited to:

In an aspect, an alloy, comprises: at least one IUPAC Group 6 element in an amount of at least about 80 weight percent; and at least one IUPAC Groups 13 and 14 element is an amount of at least about 0.01 weight percent, all based on a total weight of the alloy.

A second aspect can include the alloy of the first aspect, wherein the at least one IUPAC Group 6 element comprises tungsten, molybdenum, or a combination thereof.

A third aspect can include the alloy of the first aspect or the second aspect, wherein the at least one IUPAC Group 6 element comprises tungsten.

A fourth aspect can include the alloy of any one of the proceeding aspects, wherein the at least one IUPAC Group 6 element comprises molybdenum.

A fifth aspect can include the alloy of any one of the proceeding aspects, wherein the IUPAC Groups 13 and 14 elements comprises boron and carbon.

A sixth aspect can include the alloy of any one of the proceeding aspects, further comprising at least one additional element of another IUPAC Group 6 element, at least one element from IUPAC Groups 3-5, and 16, or a combination thereof.

A seventh aspect can include the alloy of any one of the proceeding aspects, wherein the at least one additional element comprises another IUPAC Group 6 element comprising chromium.

An eighth aspect can include the alloy of any one of the proceeding aspects, wherein the chromium is in an amount of at least about 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, or about 12 weight percent, based on the total weight of the alloy.

A ninth aspect can include the alloy of any one of the proceeding aspects, wherein the chromium is in an amount of no more than about 12 weight percent, about 11 weight percent, about 10 weight percent, about 9 weight percent, about 8 weight percent, about 7 weight percent, about 6 weight percent, about 5 weight percent, about 4 weight percent, about 3 weight percent, about 2 weight percent, or about 1 weight percent, and optionally at least about 0.0001 weight percent, based on the total weight of the alloy.

A tenth aspect can include the alloy of any one of the proceeding aspects, wherein the chromium is in an amount about 0.1 weight percent to about 12 weight percent, about 0.1 weight percent to about 1 weight percent, about 1 weight percent to about 2 weight percent, about 2 weight percent to about 3 weight percent, about 3 weight percent to about 4 weight percent, about 4 weight percent to about 5 weight percent, about 5 weight percent to about 6 weight percent, about 6 weight percent to about 7 weight percent, about 8 weight percent to about 9 weight percent, about 9 weight percent to about 10 weight percent, about 10 weight percent to about 11 weight percent, or about 11 weight percent to about 12 weight percent, based on the total weight of the alloy.

An eleventh aspect can include the alloy of any one of the proceeding aspects, wherein the at least one additional element comprises another IUPAC Group 5 element comprising niobium.

A twelfth aspect can include the alloy of any one of the proceeding aspects, wherein the niobium is in an amount of at least about 1 weight percent, about 2 weight percent, about 3 weight percent, about 4 weight percent, about 5 weight percent, about 6 weight percent, about 7 weight percent, about 8 weight percent, about 9 weight percent, about 10 weight percent, about 11 weight percent, or about 12 weight percent, based on the total weight of the alloy.

A thirteenth aspect can include the alloy of any one of the proceeding aspects, wherein the niobium is in an amount of no more than about 12 weight percent, about 11 weight percent, about 10 weight percent, about 9 weight percent, about 8 weight percent, about 7 weight percent, about 6 weight percent, about 5 weight percent, about 4 weight percent, about 3 weight percent, about 2 weight percent, or about 1 weight percent, and optionally at least about 0.0001 weight percent, based on the total weight of the alloy.

A fourteenth aspect can include the alloy of any one of the proceeding aspects, wherein the niobium is in an amount about 0.1 weight percent to about 12 weight percent, about 0.1 weight percent to about 1 weight percent, about 1 weight percent to about 2 weight percent, about 2 weight percent to about 3 weight percent, about 3 weight percent to about 4 weight percent, about 4 weight percent to about 5 weight percent, about 5 weight percent to about 6 weight percent, about 6 weight percent to about 7 weight percent, about 8 weight percent to about 9 weight percent, about 9 weight percent to about 10 weight percent, about 10 weight percent to about 11 weight percent, or about 11 weight percent to about 12 weight percent, based on the total weight of the alloy.

A fifteenth aspect can include the alloy of any one of the proceeding aspects, wherein the at least one additional element comprises at least one IUPAC Group 3 element, comprising yttrium.

A sixteenth aspect can include the alloy of any one of the proceeding aspects, wherein the at least one additional element comprises at least one IUPAC Group 4 element, comprising titanium, zirconium, hafnium, niobium, or a combination thereof, optionally having a solidus temperature selected from the group consisting of no more than about 3,000 K or at least about 3,000 K.

A seventeenth aspect can include the alloy of any one of the proceeding aspects, wherein the at least one additional element comprises at least one IUPAC Group 5 element, comprising vanadium, tantalum, or a combination thereof, and the alloy further comprises zirconium.

An eighteenth aspect can include the alloy of any one of the proceeding aspects, further comprising an IUPAC Group 16 element, comprising oxygen.

A nineteenth aspect can include the alloy of any one of the proceeding aspects, wherein the at least one IUPAC Group 6 element is in an amount of at least about 82 weight percent, about 84 weight percent, about 86 weight percent, about 88 weight percent, about 90 weight percent, about 92 weight percent, about 94 weight percent, about 96 weight percent, about 98 weight percent, or about 99 weight percent, based on the total weight of the alloy.

A twentieth aspect can include the alloy of any one of the proceeding aspects, wherein the at least one IUPAC Group 6 element is in an amount of no more than about 99 weight percent, about 98 weight percent, about 96 weight percent, about 94 weight percent, about 92 weight percent, about 90 weight percent, about 88 weight percent, about 86 weight percent, about 84 weight percent, or about 82 weight percent, based on the total weight of the alloy.

A twenty-first aspect can include the alloy of any one of the proceeding aspects, wherein the at least one IUPAC Group 6 element is in an amount of about 80 weight percent to about 82 weight percent, about 82 weight percent to about 84 weight percent, about 84 weight percent to about 86 weight percent, about 86 weight percent to about 88 weight percent, about 88 weight percent to about 90 weight percent, about 90 weight percent to about 92 weight percent, about 92 weight percent to about 94 weight percent, about 94 weight percent to about 96 weight percent, about 96 weight percent to about 98 weight percent, or about 98 weight percent to about 99 weight percent, based on the total weight of the alloy.

A twenty-second aspect can include the alloy of any one of the proceeding aspects, wherein the carbon is in an amount of at least about 0.01 weight percent, about 0.05 weight percent, about 0.1 weight percent, about 0.15 weight percent, about 0.2 weight percent, about 0.25 weight percent, or about 0.3 weight percent, based on the total weight of the alloy.

A twenty-third aspect can include the alloy of any one of the proceeding aspects, wherein the carbon is in an amount of no more than about 0.6 weight percent, about 0.5 weight percent, about 0.4 weight percent, about 0.3 weight percent, about 0.25 weight percent, about 0.2 weight percent, about 0.15 weight percent, about 0.1 weight percent, about 0.05 weight percent, or about 0.01 weight percent, based on the total weight of the alloy.

A twenty-fourth aspect can include the alloy of any one of the proceeding aspects, wherein the carbon is in an amount of about 0.01 weight percent to about 0.6 weight percent, about 0.01 weight percent to about 0.05 weight percent, about 0.05 weight percent to about 0.1 weight percent, about 0.1 weight percent to about 0.15 weight percent, about 0.15 weight percent to about 0.2 weight percent, about 0.2 weight percent to about 0.25 weight percent, about 0.25 weight percent to about 0.3 weight percent, about 0.3 weight percent to about 0.4 weight percent, about 0.4 weight percent to about 0.5 weight percent, or about 0.5 weight percent to about 0.6 weight percent, based on the total weight of the alloy.

A twenty-fifth aspect can include the alloy of any one of the proceeding aspects, wherein the alloy is a ternary compound.

A twenty-sixth aspect can include the alloy of any one of the proceeding aspects, wherein the alloy is a quaternary compound.

A twenty-seventh aspect can include the alloy of any one of the proceeding aspects, wherein the alloy has a yield strength of at least about 700 MPa, about 720 MPa, about 740 MPa, about 760 MPa, about 780 MPa, about 800 MPa, about 820 MPa, or about 825 MPa; a maximum compressive strength of at least about 1,200 MPa, about 1,240 MPa, about 1,280 MPa, about 1,320 MPa, or about 1,340 MPa; and a Vickers Pyramid Number of at least about 500 HV, about 520 HV, about 540 HV, about 560 HV, about 580 HV, or about 600 HV, about 620 HV, about 640 HV, about 660 HV, about 680 HV, about 700 HV, about 720 HV, about 740 HV, about 760 HV, about 780 HV, about 800 HV or about 820 HV.

In a twenty-eighth aspect, an alloy comprises a formula of at least one of: W—Cr—C(—O); W—Nb—C(—O); W—Ta—Zr—C(—O); W—(Hf/Ta/Mo)—X—Y—C(—O), where X and Y are, independently, elements; or Mo—Ti—Zr—C(—O).

In a twenty-ninth aspect, a method for forming an alloy comprising printing a metal alloy composition of at least one element of from IUPAC Groups 3-6, and an element from IUPAC Group 13 or 14 by laser-powder bed fusion (L-PBF) at a suitable laser-power (P), a scanning-speed (ν), a temperature (t), and a hatch distance (hd) for forming an alloy.

A thirtieth aspect can include the method of the twenty-ninth aspect, wherein P is about 150 Watts to about 1,000 Watts, about 400 Watts to about 900 Watts, or about 550 Watts to about 700 Watts; wherein ν is about 10 mm/s to about 2,000 mm/s, about 300 mm/s to about 700 mm/s, or about 300 mm/s to about 500 mm/s; t is about 100° C. to about 1,000°C, about 400° C. to about 1,000°C, or about 400° C. to about 600° C.; and hd is about 1 μm to about 200 μm, about 80 μm to about 120 μm, or about 90 μm to about 110 μm.

A thirty-first aspect can include the method of the twenty-ninth aspect or the thirtieth aspect, wherein the formed alloy comprises at least one isomorphous region and at least one spinodal region, the method further comprising heat treating the at least one isomorphous region, aging the at least one spinodal region, or both.

In a thirty-second aspect, an atomized powder mixture for laser-powder bed fusion additive three-dimensional printer, comprises: an amount of tungsten of about 80 weight percent to about 99 weight percent, about 80 weight percent to about 82 weight percent, about 82 weight percent to about 84 weight percent, about 84 weight percent to about 86 weight percent, about 86 weight percent to about 88 weight percent, about 88 weight percent to about 90 weight percent, about 90 weight percent to about 92 weight percent, about 92 weight percent to about 94 weight percent, about 94 weight percent to about 96 weight percent, about 96 weight percent to about 98 weight percent, or about 98 weight percent to about 99 weight percent; an amount of chromium of about 0.1 weight percent to about 12 weight percent, about 0.1 weight percent to about 1 weight percent, about 1 weight percent to about 2 weight percent, about 2 weight percent to about 3 weight percent, about 3 weight percent to about 4 weight percent, about 4 weight percent to about 5 weight percent, about 5 weight percent to about 6 weight percent, about 6 weight percent to about 7 weight percent, about 7 weight percent to about 8 weight percent, about 8 weight percent to about 9 weight percent, about 9 weight percent to about 10 weight percent, about 10 weight percent to about 11 weight percent, or about 11 weight percent to about 12 weight percent; and an amount of carbon of about 0.01 weight percent to about 0.6 weight percent, about 0.01 weight percent to about 0.05 weight percent, about 0.05 weight percent to about 0.1 weight percent, about 0.1 weight percent to about 0.15 weight percent, about 0.15 weight percent to about 0.2 weight percent, about 0.2 weight percent to about 0.25 weight percent, about 0.25 weight percent to about 0.3 weight percent, about 0.3 weight percent to about 0.4 weight percent, about 0.4 weight percent to about 0.5 weight percent, or about 0.5 weight percent to about 0.6 weight percent, based on the total weight of the atomized powder mixture.

In a thirty-third aspect, an atomized powder mixture for laser-powder bed fusion additive three-dimensional printer, comprises: an amount of tungsten of about 80 weight percent to about 99 weight percent, about 80 weight percent to about 82 weight percent, about 82 weight percent to about 84 weight percent, about 84 weight percent to about 86 weight percent, about 86 weight percent to about 88 weight percent, about 88 weight percent to about 90 weight percent, about 90 weight percent to about 92 weight percent, about 92 weight percent to about 94 weight percent, about 94 weight percent to about 96 weight percent, about 96 weight percent to about 98 weight percent, or about 98 weight percent to about 99 weight percent; an amount of niobium of about 0.1 weight percent to about 12 weight percent, about 0.1 weight percent to about 1 weight percent, about 1 weight percent to about 2 weight percent, about 2 weight percent to about 3 weight percent, about 3 weight percent to about 4 weight percent, about 4 weight percent to about 5 weight percent, about 5 weight percent to about 6 weight percent, about 6 weight percent to about 7 weight percent, about 7 weight percent to about 8 weight percent, about 8 weight percent to about 9 weight percent, about 9 weight percent to about 10 weight percent, about 10 weight percent to about 11 weight percent, or about 11 weight percent to about 12 weight percent; and an amount of carbon of about 0.01 weight percent to about 0.6 weight percent, about 0.01 weight percent to about 0.05 weight percent, about 0.05 weight percent to about 0.1 weight percent, about 0.1 weight percent to about 0.15 weight percent, about 0.15 weight percent to about 0.2 weight percent, about 0.2 weight percent to about 0.25 weight percent, about 0.25 weight percent to about 0.3 weight percent, about 0.3 weight percent to about 0.4 weight percent, about 0.4 weight percent to about 0.5 weight percent, or about 0.5 weight percent to about 0.6 weight percent, based on the total weight of the atomized powder mixture.

A thirty-fourth aspect can include a method of three-dimensional printing of an article, comprising placing the atomized powder mixture of the thirty-second aspect or the thirty-third aspect into a laser-powder bed fusion additive apparatus, and heating with a laser to melt the atomized powder mixture to form the alloy.

A thirty-fourth aspect can include the method of the thirty-fourth aspect, wherein the article is comprised in a fuel cladding, a fuel matrix, a fuel element, a channel material in a nuclear thermal propulsion engine, a refractory alloy for a space propulsion sub-component, a rocket nozzle, a wing leading edge heat pipe, a nuclear casing, a thrust chamber, or a combination thereof.

For purposes of the disclosure herein, the term “comprising” includes “consisting” or “consisting essentially of.” Further, for purposes of the disclosure herein, the term “including” includes “comprising,” “consisting,” or “consisting essentially of.”

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

While embodiments of the invention have been shown and described, modifications thereof can be made by one skilled in the art without departing from the spirit and teachings of the invention. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

What is claimed is:

1. An alloy, comprising:
at least one IUPAC Group 6 element in an amount of at least about 80 weight percent; and
at least one IUPAC Groups 13 and 14 element is an amount of at least about 0.01 weight percent, all based on a total weight of the alloy.

2. The alloy of claim 1, wherein the at least one IUPAC Group 6 element comprises tungsten, molybdenum, or a combination thereof.

3. The alloy of claim 1, wherein the at least one IUPAC Group 6 element comprises tungsten.

4. The alloy of claim 1, wherein the at least one IUPAC Group 6 element comprises molybdenum.

5. The alloy of claim 1, wherein the IUPAC Groups 13 and 14 elements comprises boron and carbon.

6. The alloy of claim 1, further comprising at least one additional element of another IUPAC Group 6 element, at least one element from IUPAC Groups 3-5, and 16, or a combination thereof.

7. The alloy of claim 6, wherein the at least one additional element comprises another IUPAC Group 6 element comprising chromium.

8. The alloy of claim 7, wherein the chromium is in an amount of at least about 1 weight percent, based on the total weight of the alloy.

9. The alloy of claim 7, wherein the chromium is in an amount of no more than about 12 weight percent, based on the total weight of the alloy.

10. The alloy of claim 7, wherein the chromium is in an amount about 0.1 weight percent to about 12 weight percent, based on the total weight of the alloy.

11. The alloy of claim 6, wherein the at least one additional element comprises another IUPAC Group 5 element comprising niobium.

12. The alloy of claim 11, wherein the niobium is in an amount of at least about 1 weight percent, based on the total weight of the alloy.

13. The alloy of claim 11, wherein the niobium is in an amount of no more than about 12 weight percent, based on the total weight of the alloy.

14. The alloy of claim 11, wherein the niobium is in an amount about 0.1 weight percent to about 12 weight percent, based on the total weight of the alloy.

15. The alloy of claim 6, wherein the at least one additional element comprises at least one IUPAC Group 3 element, comprising yttrium.

16. The alloy of claim 6, wherein the at least one additional element comprises at least one IUPAC Group 4 element, comprising titanium, zirconium, hafnium, niobium, or a combination thereof, optionally having a solidus temperature selected from the group consisting of no more than about 3,000 K or at least about 3,000 K.

17. The alloy of claim 6, wherein the at least one additional element comprises at least one IUPAC Group 5 element, comprising vanadium, tantalum, or a combination thereof, and the alloy further comprises zirconium.

18. The alloy of claim 1, further comprising an IUPAC Group 16 element, comprising oxygen.

19. An alloy, comprising a formula of at least one of:
W—Cr—C(—O);
W—Nb—C(—O);
W—Ta—Zr—C(—O);
W—(Hf/Ta/Mo)—X—Y—C(—O), where X and Y are, independently, elements; or
Mo—Ti—Zr—C(—O).

20. A method for forming an alloy comprising printing a metal alloy composition of at least one element of from IUPAC Groups 3-6, and an element from IUPAC Group 13 or 14 by laser-powder bed fusion (L-PBF) at a suitable laser-power (P), a scanning-speed (ν), a temperature (t), and a hatch distance (hd) for forming the alloy.
